(19) United States
(12) Patent Application Publication
(10) Pub. No.: US 2008/0309638 A1
(43) Pub. Date: Dec. 18, 2008

(54) INPUT DEVICE AND METHOD OF MANUFACTURING MODULE UNIT FOR INPUT DEVICE

(75) Inventor: Naoki Tatehata, Kyoto (JP)

Correspondence Address: RATNERPRESTIA, P.O. BOX 980, VALLEY FORGE, PA, 19482, US

(73) Assignee: Matsushita Electric Industrial Co., Ltd., Osaka (JP)

(21) Appl. No.: 12/106,602

(22) Filed: Apr. 21, 2008

(30) Foreign Application Priority Data
Jun. 14, 2007 (JP) 2007-157214

(51) Int. Cl. G06F 3/041

(52) U.S. Cl. 345/173

(57) ABSTRACT

An input device comprises a wiring board having stationary contacts and a module unit placed on the wiring board. The module unit has a structure formed integrally with actuating key portions, movable contacts, cushioning members and protruding portions. The movable contacts are disposed under the actuating key portions, and actuated by a push-on operation of the actuating key portions. The cushioning members are disposed in a space between a lower surface of the actuating key portions and an upper surface of a movable contact retainer bearing the movable contacts to make the space shrinkable when subjected to the push-on operation whereas it maintains an uniform height when not subjected to the push-on operation. The protruding portions depress top center portions of the movable contacts. The input device includes switch elements, each comprising the movable contact and the stationary contact, and the switch element is actuated by the push-on operation on the actuating key portion.

### FIELD OF THE INVENTION

The present invention relates to input devices constituting input operation units of various electronic apparatuses and a method of manufacturing module units for the input devices.

### BACKGROUND OF THE INVENTION

Many input devices used widely as input operation units of various electronic apparatuses such as mobile telephones are equipped with push button type input means, and these input devices are so constructed as to accept entry of telephone numbers and the like through operation of the input means.

With the well-established infrastructure of the Internet communications in recent years, Internet web-pages are frequently browsed even with mobile telephones, which have given rise to the need for the mobile telephones to have the function of moving a cursor freely in a display.

The need to perform the above operating function has yielded new designs of input devices of such a structure that comprises a combination of a coordinate input device for moving a cursor in a display and a push-on type input device for entering telephone numbers and the like.

Referring now to FIG. 12, description is provided of a conventional input device of such structure. FIG. 12 is an exploded perspective view of an electronic apparatus equipped with the conventional input device, wherein the figure specifically illustrates electronic communication terminal 101.

An operator can enter a coordinate data into electronic communication terminal 101 by using coordinate input device 102 shown in FIG. 12. Also provided under coordinate input device 102 is a push-on type input device consisting of a plurality of switches 105 of push-to-operate type disposed in predetermined positions on a bottom surface of recessed space 104 within an enclosure. The operator can operate the individual switches 105 by pushing them from above coordinate input device 102.

The operator slides one of her fingers horizontally along the surface of coordinate input device 102 to input a coordinate data. Coordinate input device 102 includes a capacitive sensor consisting of electrodes of a prescribed pattern formed on an insulation film (not shown in the figure) as a sensor element. When the operator slides her finger on the surface of coordinate input device 102, a capacitance of the capacitive sensor in coordinate input device 102 changes responsive to a position of the finger because the finger is electrically conductive. This change in the capacitance is detected by a control unit (not shown), which in turn executes a predetermined process to determine a location of the coordinates.

The push-on input operation stated above is carried out by pushing any of symbol markings 103 indicating numerals, etc. on a main surface at the upper side of coordinate input device 102. When the push-on input operation is made, coordinate input device 102 is partially warped downward at and around the pressed portion of symbol markings 103. This depresses a dome-like portion of corresponding one of switches 105 disposed in positions under coordinate input device 102, and makes an electrical continuity between at least two conductive parts (not shown) inside the switch 105.

As a result, display 106 shows data corresponding to the coordinate input operation and the push-on input operation.

Japanese Patent Unexamined Publication, No. 2002-123363, for example, is one of the prior art documents known to be relevant to the above conventional art.

In the conventional input device of this kind, however, some space is needed under coordinate input device 102 because the individual switches 105 are to be operated by being pushed from above coordinate input device 102.

Because of this space, the surface of coordinate input device 102 tends to deform downward around the area being touched when the operator slides her finger along the surface for the input operation. When this occurs the condition of contact changes between coordinate input device 102 and the finger, which results in a change of the capacitance. This gives rise to a problem of reducing an accuracy of detecting the location of coordinates since it is determined based on the change in the capacitance.

In designing an electronic apparatus provided with a conventional input device, it is definitely necessary that switches 105 are so disposed as to be depressed positively at the centers of their dome-like portions in order for them to yield good tactile feeling when subjected to the push-on operation. It is necessary for this purpose that coordinate input device 102 is assembled with the centers of symbol markings 103 in proper alignment with the plurality of switches 105 disposed on the bottom surface of recessed space 104 in the enclosure. In addition, switches 105 of small and low-profile type have now been the preferred choice for use in the downsized electronic apparatuses of recent years. It is therefore becoming more difficult to assemble switches 105 since the operable areas for yielding an excellent tactile feeling to the push-on operation become smaller with this trend of downsizing.

### SUMMARY OF THE INVENTION

An input device of the present invention comprises a wiring board provided with a stationary contact, and a module unit placed on the wiring board.

The module unit has a structure formed integrally with actuating key portions, movable contacts, a cushioning member and protruding portions. The movable contacts are disposed under the actuating key portions, and actuated by a push-on operation of any of the actuating key portions. The cushioning member is disposed in a space between a lower surface of the actuating key portion and an upper surface of a movable contact retainer bearing the movable contacts to make the space shrinkable when subjected to the push-on operation whereas it maintains an uniform height when not subjected to the push-on operation. The protruding portions depress top center portions of the movable contacts. The input device includes switch elements, each comprising the movable contact and the stationary contact, and the switch elements are actuated by the push-on operation through the actuating key portions.

In addition, the actuating key portions may be composed to also function as a coordinate input controller for accepting an entry of coordinate data according to a change in capacitance responsive to a movement of a finger of an operator.

By virtue of this structure, the invention provides the input device which can be made simply by mounting the module unit onto the wiring board with few assembling processes, yet the movable contacts are reliably depressed at their center portions via the protruding portions when subjected to the push-on operation.

In this module unit, the coordinate input controller and the movable contact retainer are integrated into one unit with the cushioning member placed between them. Because the coordinate input controller is supported with the cushioning member this structure can abate the phenomenon of the coordinate input controller being deformed downward when the finger is slid along the surface thereof. The invention can thus provide the input device capable of detecting a location of coordinates steadily and highly accurately.

According to the present invention, a method of manufacturing the module unit used for the input device of this invention comprises the following steps. That is, the first step is to prepare a capacitive sensor and a movable contact assembly, and print a resin paste mixed with a foaming agent on one of the capacitive sensor and the movable contact assembly in a prescribed pattern corresponding to an arrangement of cushioning member. The next step is to place the other one of the capacitive sensor and the movable contact assembly in a manner to confront the one bearing the resin paste printed thereon with a space kept therebetween of a dimension equal to a given height of the cushioning member. The another step is to foam and harden the resin paste to form the cushioning member and bond to the capacitive sensor and the movable contact assembly while maintaining the height dimension fixed by them.

According to this method, it becomes possible to manufacture with few assembling processes the module unit for the input device provided with the cushioning member having both the upper and lower surfaces bonded to their corresponding ones of the capacitive sensor and the movable contact assembly while maintaining the uniform height throughout.

### BRIEF DESCRIPTION OF THE DRAWINGS

FIG. 1 is an exploded perspective view of a module unit, a principal component of an input device according to a first exemplary embodiment of the present invention;

FIG. 2 is a sectional view of the module unit for the input device according to the first exemplary embodiment;

FIG. 3 is a sectional view of a complete input device including a wiring board and the module unit shown in FIG. 2;

FIG. 4 is a sectional view of a module unit, a principal component of another input device according to a second exemplary embodiment of the present invention;

FIG. 5 is a sectional view of a complete input device including a wiring board and the module unit shown in FIG. 4;

FIG. 6 is a sectional view showing a part of the module unit of the first exemplary embodiment referred to in describing a manufacturing method thereof according to a third exemplary embodiment of the present invention;

FIG. 7 is another view of the part of the module unit associated with the same manufacturing method;

FIG. 8 is still another view of the part of the module unit associated with the same manufacturing method;

FIG. 9 a sectional view showing a part of the module unit of the second exemplary embodiment referred to in describing a manufacturing method according to a fourth exemplary embodiment of the present invention;

FIG. 10 is another view of the part of the module unit associated with the same manufacturing method;

FIG. 11 is still another view of the part of the module unit associated with the same manufacturing method; and

FIG. 12 is an exploded perspective view of an electronic apparatus equipped with a conventional input device.

### DETAILED DESCRIPTION OF PREFERRED EMBODIMENT

Referring to the accompanying drawings description is provided hereinafter of the exemplary embodiments of the present invention.

### First Exemplary Embodiment

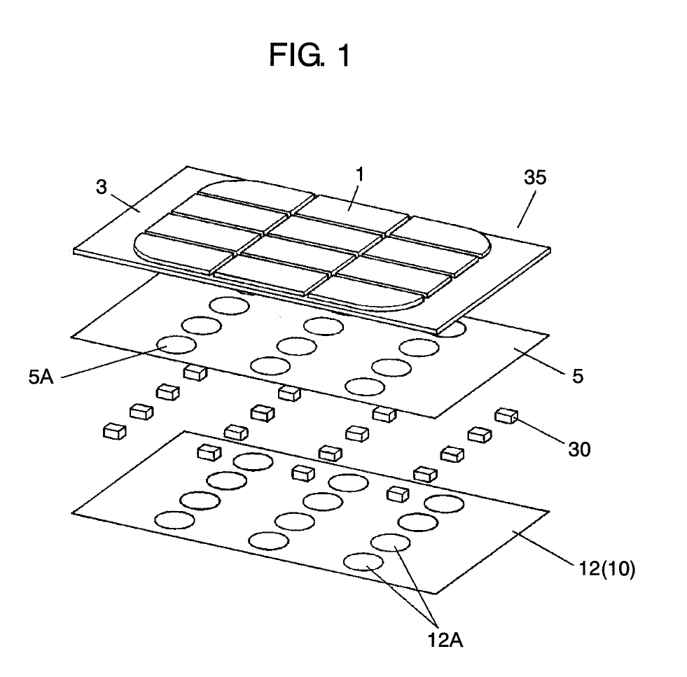

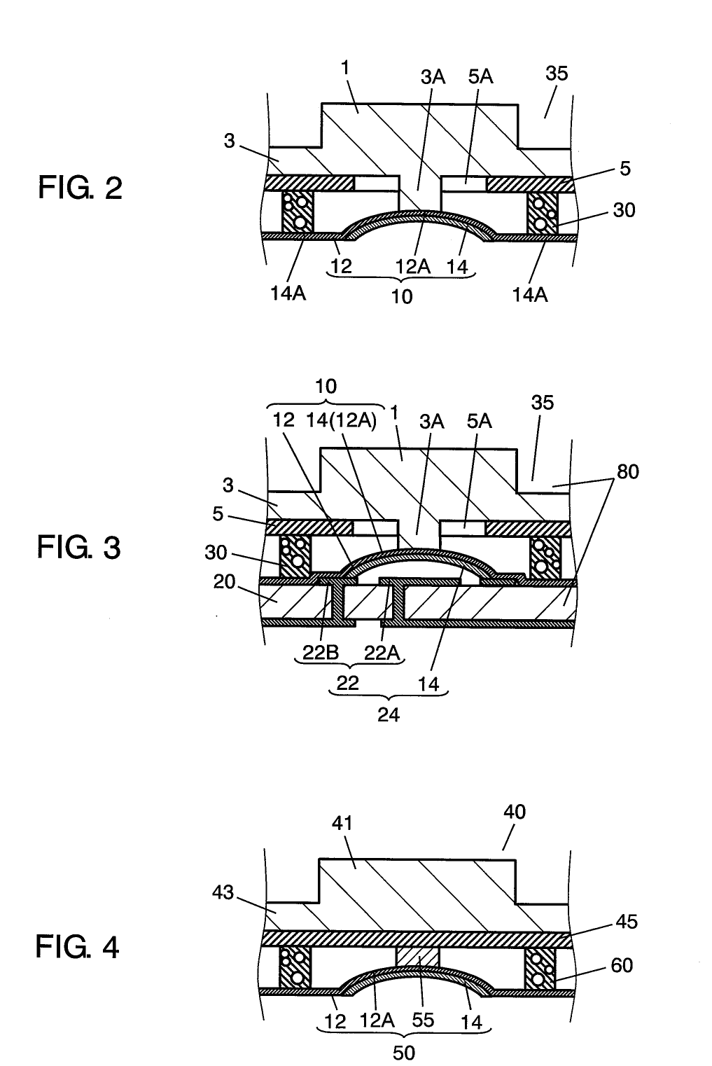

FIG. 1 is an exploded perspective view of a module unit, a principal component of an input device according to the first exemplary embodiment of the present invention, FIG. 2 is a sectional view of the module unit for the input device according to the first exemplary embodiment, and FIG. 3 is a sectional view of a complete input device including a wiring board and the module unit shown in FIG. 2.

Referring now to FIG. 1 to FIG. 3, description is provided of a main structure of input device 80 according to the first exemplary embodiment of this invention.

Module unit 35 has a structure formed integrally with actuating key portions 1, movable contacts 14, cushioning member 30 and protruding portions 3A. Movable contacts 14 are disposed under actuating key portions 1, and actuated by a push-on operation of actuating key portions 1. Cushioning member 30 of a sponge-like material is disposed on a space between a lower surface of actuating key portions 1 and an upper surface of movable contact retainer 14A bearing movable contacts 14 so that the space is shrinkable when subjected to the push-on operation whereas it maintains an uniform height when not subjected to the push-on operation. Protruding portions 3A depress the top center portions of movable contacts 14. Input device 80 includes switch elements 24, each comprising movable contact 14 and stationary contact 22, and switch elements 24 are actuated by the push-on operation through actuating key portions 1.

Description is provided in more detail of the input device according to the first exemplary embodiment of this invention with reference to FIG. 1 to FIG. 3.

A plurality of actuating key portions 1 are formed into rows of a predetermined pattern on an upper surface of key mat 3 made of a rubber of the like material having elasticity, as shown in FIG. 1. Actuating key portions 1 are individually marked with symbols such as numerals on their top surfaces though not shown in the figures.

Actuating key portions 1 may be formed of a plastic material such as polycarbonate into separate components and bonded to key mat 3, instead of the structure shown in FIG. 2, wherein actuating key portions 1 and key mat 3 are formed unitary with a plastic or rubber material having elasticity.

Capacitive sensor 5 is bonded to the underside of key mat 3 into a double-layered configuration. Capacitive sensor 5 is connected to a control unit such as a controller IC (not shown in the figures). Capacitive sensor 5 used in this application is an insulation film such as PET film (polyethylene terephthalate film) provided with electrodes of a given pattern formed of silver, carbon, or the like material.

As shown in FIG. 2 and FIG. 3, key mat 3 is provided on the underside surface with protruding portions 3A of generally a cylindrical shape having a small diameter formed unitary in a protruding manner from positions corresponding to the individual actuating key portions 1. These protruding portions 3A protrude downward through respective perforations 5A formed in the corresponding positions of capacitive sensor 5. The lower ends of protruding portions 3A are in contact with the upper center portions of their respective convex portions 12A of movable contact assembly 10, which will be described later.

In this input device of the first exemplary embodiment, key mat 3 having actuating key portions 1 bonded together with capacitive sensor 5 constitute a coordinate input controller.

In other words, the input device according to the first exemplary embodiment has a structure including capacitive sensor 5. More specifically, actuating key portions 1 in combination with capacitive sensor 5 bonded to them constitute the coordinate input controller, with which a coordinate data is input according to a change in capacitance responsive to a movement of a finger of an operator on the upper surfaces of actuating key portions 1.

Movable contact assembly 10 comprises sheet 12 and movable contacts 14. Sheet 12 is formed of a sheet of insulation film such as PET and TPU (thermoplastic polyurethane). Movable contacts 14 have a circular or oval shape, and they are formed of a resilient thin metal sheet into a dome-like shape with their center portions convexed upward.

Sheet 12 is provided with convex portions 12A of a shape resembling the dome-like shape of movable contacts 14 at positions corresponding to those of movable contacts 14. The individual movable contacts 14 are positioned in convex portions 12A with their center portions in alignment with each other and securely fixed to the inner surfaces of convex portions 12A by an adhesive layer formed on sheet 12. This sheet 12 serves as movable contact retainer 14A, and it has a surface covering not only convex portions 12A corresponding to the dome-shaped movable contacts 14 but an area extending beyond movable contacts 14. In other words, movable contact retainer 14A formed of sheet 12 includes movable contacts 14.

Movable contact assembly 10 is aligned with and disposed on wiring board 20. Wiring board 20 is provided with at least two independent stationary contacts 22 (i.e., 22A and 22B) corresponding to each of movable contacts 14. Each of movable contacts 14 and the corresponding pair of stationary contacts 22 compose a single unit of push-on type switch element 24, so that the plurality of switches 24 arranged in positions on a flat plane constitute a so-called panel switch. Stationary contacts 22A and 22B are individually wired for external connections via through-holes and conductive traces formed on the underside of wiring board 20.

While the input device of the first exemplary embodiment comprises actuating key portions 1 including capacitive sensor 5, it also has sponge-like cushioning member 30 disposed between a lower surface of capacitive sensor 5 (i.e., the lower surface of actuating key portions 1) and an upper surface of sheet 12 of movable contact assembly 10 (i.e., the upper surface of movable contact retainer 14A). Cushioning member 30 is shrinkable when subjected to a pressure applied during a push-on operation through switch element 24. Since cushioning member 30 has its upper surface bonded to the lower surface of capacitive sensor 5 and its lower surface to the upper surface of sheet 12, as illustrated above, capacitive sensor 5 is hence supported from the underside with cushioning member 30 and maintained horizontally.

Cushioning member 30 is so designed that it is compressible to an extent greater than an operational stroke of movable contacts 14. Such design of cushioning member 30 can abate an adverse effect to the push-on operation of switch elements 24, so as to allow movable contacts 14 to function smoothly while providing an excellent tactile feeling to the operator.

Cushioning member 30 is disposed to an area other than convex portions 12A covering movable contacts 14, or the area surrounding movable contacts 14. Cushioning member 30 is formed uniformly in height, as mentioned above, in order to maintain capacitive sensor 5 horizontally.

There are many ways, without specific limitations, to make cushioning member 30 of an uniform height and to bond it to both capacitive sensor 5 and sheet 12. One such example is to prepare separated pieces of cushioning material formed into an equal height and bond them with adhesive tapes. However, such method takes a large number of manufacturing and administration processes. There are some manufacturing methods available to form cushioning members 30 into a state of being bonded to capacitive sensor 5 and sheet 12 without presenting such drawbacks, of which details will be described later.

Although cushioning members 30 can be disposed in any area on sheet 12, it is desirable that a number of cushioning members 30 are disposed in areas around convex portions 12A in a manner that they encircle the individual convex portions 12A at positions symmetrical to one another with respect to the centers of convex portions 12A, so as to reduce the overall thickness as well as a force required to depress cushioning members 30. This structure is also desirable in the light of its little influence to the tactile feeling produced during the push-on operation. One such example is to form cushioning members 30 into a pillar shape and dispose them around convex portions 12A at equal distances from the centers thereof and at equal angular pitches of 90° or 120°. This structure enables cushioning members 30 to support capacitive sensor 5 evenly at a plurality of positions above switch elements 24. This structure also promises an advantage of easing adverse effects resulting from push-on operations at irregular angles and the like manipulation. It is also possible to achieve further simplification of the structure in addition to obtaining a similar advantage stated above when each of cushioning members 30 is provided at the position midpoint along the centerline between two adjoining convex portions 12A to serve its function for both of them.

As described above, the input device according to the first exemplary embodiment is integrally assembled except for wiring board 20. In other words, the individual components including capacitive sensor 5, movable contact assembly 10 and key mat 3 provided with protruding portions 3A for depressing movable contacts 14 disposed on movable contact assembly 10 are bonded directly or indirectly through cushioning members 30 to complete the integrated module unit 35. This makes module unit 35 of robust structure, thereby improving easiness of handling such as assembling of module unit 35 when used as an input device of an electronic apparatus such as mobile phone. For the above reason, this structure can help reduce the number of manufacturing and administration processes substantially as compared to the ordinary processes, in which the individual components are positioned and assembled one after another. In addition, module unit 35 is so integrated that protruding portions 3A of key mat 3 are aligned with the centers of convex portions 12A of movable contact assembly 10 before they are assembled together. By virtue of this structure, the input device can be assembled simply by positioning and mounting module unit 35 onto wiring board 20, thereby avoiding a deviation in alignment of the operating positions from the movable contacts, which is liable to occur in the conventional device during assembling of the individual components. Accordingly, the first exemplary embodiment can achieve the input device having switch elements 24 capable of providing an excellent tactile feeling in the push-on operation.

It is desirable to use capacitive sensor 5 as a detection means for the coordinate input operation in order to compose module unit 35 of the above configuration and to achieve a low-profile structure. However, it is not intended to limited the present invention only to the embodied structure illustrated above. The above structure can prevent capacitive sensor 5 from being stained or deteriorated since capacitive sensor 5 can be operated without being touched directly, thereby providing an advantage in terms of the reliability and operating life.

The input device constructed of module unit 35 and corresponding wiring board 20 according to the first exemplary embodiment operates in a manner, which is described hereinafter.

When a coordinate input operation is made through input device 80 shown in FIG. 3, that is, an operator slides her finger on the surfaces of actuating key portions 1, a capacitance of capacitive sensor 5 changes responsive to a position of the finger. A data of this capacitance is detected by a control unit (not shown), which in turn executes a predetermined process to determine a location of coordinates. Input device 80 is so constructed that actuating key portions 1 are supported at their center areas from below by protruding portions 3A, and capacitive sensor 5 is supported at areas of its underside surface around convex portions 12A of the individual switch elements 24 by cushioning members 30. By virtue of this structure, actuating key portions 1 are not likely to become unduly deformed downward at the area subjected to the sliding operation of the finger, so as to avoid a significant change in the distance between the finger on actuating key portions 1 and capacitive sensor 5. This structure can thus improve the detecting accuracy, thereby enabling input device 80 to detect the coordinate position steadily and highly accurately.

On the other hand, when a desired one of actuating key portions 1 is pushed, the actuating key portion 1 shifts downward to partially warp key mat 3 and capacitive sensor 5 in the area around the pushed key portion 1. This causes the corresponding one of protruding portions 3A to exert a depressing force upon movable contact 14 over convex portion 12A while also compressing cushioning members 30 provided around convex portion 12A. When the depressing force exceeds a predetermined amount, movable contact 14 gives in resiliently with a clicking motion to make an electrical continuity between a pair of stationary contacts 22A and 22B disposed on wiring board 20.

As discussed, the input device according to this first exemplary embodiment comprises module unit 35, which is so constructed that sheet 12 retaining movable contacts 14 and capacitive sensor 5 are integrated with cushioning members 30 disposed between them, and capacitive sensor 5 is securely bonded to key mat 3. In this assembly of module unit 35, key mat 3 is positioned so that the bottom ends of its protruding portions 3A are aligned and in contact with the respective convex portions 12A in a manner to make the center portions of movable contacts 14 depressible by protruding portions 3A. The input device can hence provide an excellent tactile feeling to the push-on operation without having a dependence on adequacy of the assembling work of the device into an apparatus.

When the depressing force is removed, movable contact 14 restores the original convex shape by its resiliency and pushes back protruding portion 3A through sheet 12 while breaking the electrical continuity. The input device then returns to the un-operated condition shown in FIG. 3 with the aid of restoring forces of cushioning members 30, key mat 3 and capacitive sensor 5.

As discussed above, the input device of this first exemplary embodiment comprises module unit 35 having capacitive sensor 5 supported by cushioning members 30 and integrally constructed with protruding portions 3A. Because of this structure, cushioning members 30 can prevent capacitive sensor 5 from being deformed unduly during the sliding operation, so as to improve the detecting accuracy of coordinate location and realize the input device of excellent operability even in the push-on operation.

The present invention can reduce a number of assembling processes to compose the input device having the function of accepting both the push-on operation and the coordinate input operation since all it requires is to position and mount module unit 35 onto wiring board 20.

As an alternative structure, the above input device may be modified such that cushioning members 30 are placed to bond between the upper surface of wiring board 20 and the underside surface of capacitive sensor 5.

In this first exemplary embodiment, although the input device has the coordinate input controller composed of actuating key portion 1 bonded with capacitive sensor 5, it may have a different function such that actuating key portion 1 is used for entry of other data than coordinate locations.

### Second Exemplary Embodiment

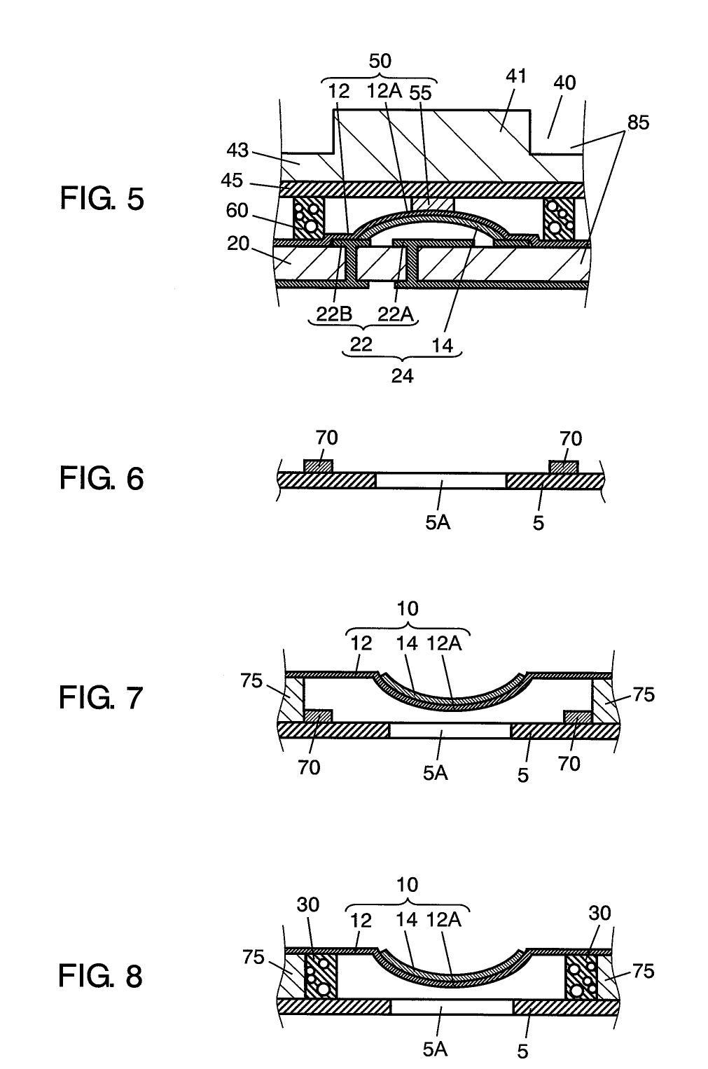

FIG. 4 is a sectional view of a module unit, a principal component of an input device according to the second exemplary embodiment of the present invention, and FIG. 5 is a sectional view of a complete input device including a wiring board and the module unit shown in FIG. 4.

Input device 85 of this second exemplary embodiment is similar to input device 80 of the first exemplary embodiment illustrated above, wherein it is assembled simply by mounting pre-integrated module unit 40 onto wiring board 20. Input device 85 of this exemplary embodiment differs from input device 80 of the first exemplary embodiment only in minor details of the components such as key mat 43, capacitive sensor 45 and movable contact assembly 50 that compose module unit 40. Description is therefore provided mainly of the different portions of input device 85, and details will be skipped of certain components having same structures and denoted by the same reference marks as those of the first exemplary embodiment.

Module unit 40 representing the principal component of input device 85 according to this second exemplary embodiment differs from that of input device 80 of the first exemplary embodiment in respect of that it employs key mat 43 of a flat shape not provided with protruding portions projecting downward, as shown in FIG. 4 and FIG. 5. Actuating key portions 41 are individually marked with symbols such as numerals on their top surfaces in the same manner as actuating key portions 1 of input device 80 of the first exemplary embodiment. Capacitive sensor 45 of a plane form not having perforations is bonded to the underside of key mat 43 into a double-layered configuration. There is movable contact assembly 50 disposed underneath capacitive sensor 45. Capacitive sensor 45 is bonded on its lower surface with an upper surfaces of cushioning members 60, and an upper surface of sheet 12 of movable contact assembly 50 is bonded to a lower surfaces of cushioning members 60. Capacitive sensor 45 and movable contact assembly 50 are integrated in this manner into one unit with cushioning members 60 placed therebetween.

Movable contact assembly 50 has the same structure as that of the first exemplary embodiment, wherein sheet 12 made of an insulation film is provided with convex portions 12A formed into a shape resembling that of movable contacts 14 at predetermined positions, and movable contacts 14 are positioned in convex portions 12A on the underside surface of sheet 12 with an adhesive. Movable contact assembly 50 used here is also provided with protruding portions 55 placed at top center areas of individual convex portions 12A. Protruding portions 55 having a small diameter and generally a cylindrical shape are securely fixed by adhesion or the like means to convex portions 12A, and their top ends are in contact with the underside surface of capacitive sensor 45 at positions respectively corresponding to the centers of the symbols marked on the individual actuating key portions 41.

Capacitive sensor 45 used in this application is a PET film provided with electrodes of a predetermined pattern formed thereon in a similar manner as that of the first exemplary embodiment, but this capacitive sensor 45 has such an advantage as not requiring a corrective process since it has no perforations that adversely influence a capacitance to be detected.

Cushioning members 60 having uniform heights are disposed in areas encircling the individual convex portions 12A to support capacitive sensor 45 from below and to maintain its horizontal position in the same manner as the first exemplary embodiment. It is desirable that cushioning members 60 are formed into a pillar shape and disposed at positions around convex portions 12A in a symmetrical manner with respect to the centers of convex portions 12A, as discussed in the first exemplary embodiment.

The present invention can provide an advantage of using integrally constructed module unit 40 of this second exemplary embodiment to easily assemble input device 85 having the function of accepting both the push-on operation and the coordinate input operation with same actuating key portions 41 by simply positioning and mounting module unit 40 onto wiring board 20.

Input device 85 constructed of module unit 40 operates in a manner which is described hereinafter.

Sliding operation with input device 80 is carried out in generally the same way as that of the first exemplary embodiment such that a finger is slid along the upper surface of key mat 43. Capacitive sensor 45 fixed to key mat 43 in a double-layered structure is supported from below by protruding portions 55 at the areas corresponding the centers of convex portions 12A constituting switch elements 24, and also by cushioning members 60 at the areas around convex portions 12A. By virtue of this structure, actuating key portions 41 are not likely to become unduly deformed downward at the area subjected to the sliding operation, so as to enable input device 85 to detect the coordinate position steadily and highly accurately.

When a marked position on any of actuating key portions 41 is pushed downward, key mat 43 and capacitive sensor 45 bonded to it shift downward at the area around the pushed portion to thereby exert a depressing force upon protruding portion 55 while also compressing cushioning members 60. This depressing force is imposed on movable contact 14 through protruding portion 55 and sheet 12. When the depressing force exceeds a predetermined amount, movable contact 14 gives in resiliently with a clicking motion to make an electrical continuity between a pair of stationary contacts 22 (i.e., stationary contacts 22A and 22B). Since module unit 40 of the second exemplary embodiment has a structure comprising the individual components including protruding portion 55 integrated with cushioning members 60 disposed therein, adequacy of its operation is not dependent upon the assembling work of the input device into an apparatus. As a result, input device 85 can provide an excellent tactile feeling to the push-on operation since the depressing force is applied positively to the center position of movable contact 14 through protruding portion 55.

When the depressing force is removed, movable contact 14 restores the original convex shape by its resiliency to break the electrical continuity, and input device 85 returns to the un-operated condition with the aid of restoring forces of cushioning members 60, key mat 43 and capacitive sensor 45.

Since input device 85 comprised of module unit 40 has protruding portions 55 placed on movable contact assembly 50, it is easy to achieve a further reduction in thickness of the device as compared to that of the first exemplary embodiment by reducing thicknesses of protruding portions 55.

The structure discussed above is an example in which module unit 40 including key mat 43 is integrated into one unit. In the structure of module unit 40, since movable contact assembly 50 provided with protruding portions 55 and capacitive sensor 45 are integrated with cushioning members 60 placed between them, these components themselves can resolve the drawbacks of the conventional device. However, key mat 43 may also be integrated together only if needed.

As an alternative structure of the second exemplary embodiment, the above input device may be modified such that cushioning members 60 are placed to bond between the upper surface of wiring board 20 and the underside surface of capacitive sensor 45.

### Third Exemplary Embodiment

FIG. 6 is a sectional view showing a part of the module unit of the first exemplary embodiment referred to in describing a manufacturing method thereof according to the third exemplary embodiment of the present invention, FIG. 7 is another view of the part of the module unit associated with the same manufacturing method, and FIG. 8 is still another view of the part of the module unit associated with the same manufacturing method.

Description is provided in this third exemplary embodiment of a method of manufacturing module unit 35, which constitutes input device 80 illustrated in the first exemplary embodiment.

The manufacturing method of module unit 35 for input device 80 mainly comprises the following steps.

The first step is to prepare capacitive sensor 5 and movable contact assembly 10, and print a resin paste mixed with a foaming agent on one of capacitive sensor 5 and movable contact assembly 10 in a prescribed pattern corresponding to an arrangement of cushioning members 30. The next step is to place the other one of capacitive sensor 5 and movable contact assembly 10 in a manner to confront the one bearing the resin paste printed thereon with a space kept therebetween of a dimension equal to a given height of cushioning members 30. The another step is to foam and harden the resin paste to form cushioning members 30 bonded to capacitive sensor 5 and movable contact assembly 10 while maintaining the height dimension fixed by them.

Description is provided in further detail of the method of manufacturing module unit 35 constituting input device 80.

Since this manufacturing method is characterized by way of integrating capacitive sensor 5 and movable contact assembly 10 especially with cushioning members 30, the following description focuses mainly on that part.

First, capacitive sensor 5 and movable contact assembly 10 are prepared. Also prepared is resin paste 70 mixed with a material as a foaming agent that produces gas when baked, such as an azo compound, sodium bicarbonate and the like for the purpose of forming cushioning members 30.

In the next step, capacitive sensor 5 is placed upside down on a table, and resin paste 70 is printed on a surface facing upward by such means as screen printing to form a state of work piece shown in FIG. 6. A printing pattern, for example, is the one shown in this figure, in which resin paste 70 is pattern printed sporadically in areas around perforations 5A of capacitive sensor 5 except for spaces confronting convex portions 12A of movable contact assembly 10 so that pillar-shaped cushioning members 30 are formed in these areas.

Subsequently, height setting member 75 formed into the same height as the desired cushioning members 30 is placed on capacitive sensor 5 in a position not printed with resin paste 70, and movable contact assembly 10 is placed upside down on top of height setting member 75, as shown in FIG. 7. It is important in this step that movable contact assembly 10 is properly positioned and placed in a manner so that areas to be bonded with cushioning members 30 confront the areas of capacitive sensor 5 where resin paste 70 is printed. It is also preferable that an additional restrictive member is placed on top of movable contact assembly 10 at the same time with height setting member 75 so as to hold movable contact assembly 10 with both height setting member 75 and the restrictive member. Placement of height setting member 75 helps ensure uniform heights of cushioning members 30 during the process of formation.

Following the above, the work piece prepared as shown in FIG. 7 is baked to bring resin paste 70 to foam. At the same time with or subsequent to the baking process, resin paste 70 is hardened to form cushioning members 30 of the shape as shown in FIG. 8. Afterwards, height setting member 75 is removed. The above method of forming cushioning members 30 can provide such advantages as establishing the uniform heights of cushioning members 30 at the same time they are formed, properly bonding both sides of cushioning members 30 to capacitive sensor 5 and sheet 12 of movable contact assembly 10, and reducing a number of the working processes.

Subsequent to the above step, key mat 3 is positioned and bonded to a surface of capacitive sensor 5 opposite the side where movable contact assembly 10 is bonded so as to complete module unit 35 for the input device of the first exemplary embodiment shown in FIG. 2.

What has been discussed above is the example of printing resin paste 70 on capacitive sensor 5 and forming cushioning members 30. However, resin paste 70 may be printed into the prescribed pattern on sheet 12 of movable contact assembly 10 instead of capacitive sensor 5, and bonding it to capacitive sensor 5 while restricting the heights of cushioning members 30 by height setting member 75. Details of these processes will not be repeated since they are similar to those described above.

In either of these cases, it can be appropriate to use movable contact assembly 10 bonded together with corresponding wiring board 20 beforehand. In addition, cushioning members 30 can be formed between wiring board 20 and capacitive sensor 5 to compose the input device in the same manner.

It is also possible to use a thermosetting type resin as an alternative material of resin paste 70. When this is the case, resin paste 70 can be heated at once to foam the foaming agent while hardening it at the same time. It is conceivable, however, that heights of cushioning members 30 become uneven immediately after hardening because the hardening process takes place simultaneously with the process of foaming. It is therefore desirable that the foaming temperature is set lower than the hardening temperature of resin paste 70 so as to carry out the foaming and the hardening in two steps.

An UV (i.e., ultraviolet rays) curing type resin may also be used for resin paste 70. When such a material is used, it can be hardened by UV irradiation only after it is heated to foam the foaming agent. This ensures the foaming agent to foam more steadily to complete cushioning members 30 of even dimensions, and to make them bond more securely to sheet 12 of movable contact assembly 10.

In another example of using a soft resin material such as urethane for resin paste 70 to form cushioning members 30, the result can be such that cushioning members 30 are readily compressible in the push-on operation as well as the input unit that is smoothly operable with excellent tactile feeling to the push-on operation.

Since there are many kinds of materials useful for resin paste 70 beside those discussed above, it is desirable to select a suitable one according to the properties required for the specific application.

### Fourth Exemplary Embodiment

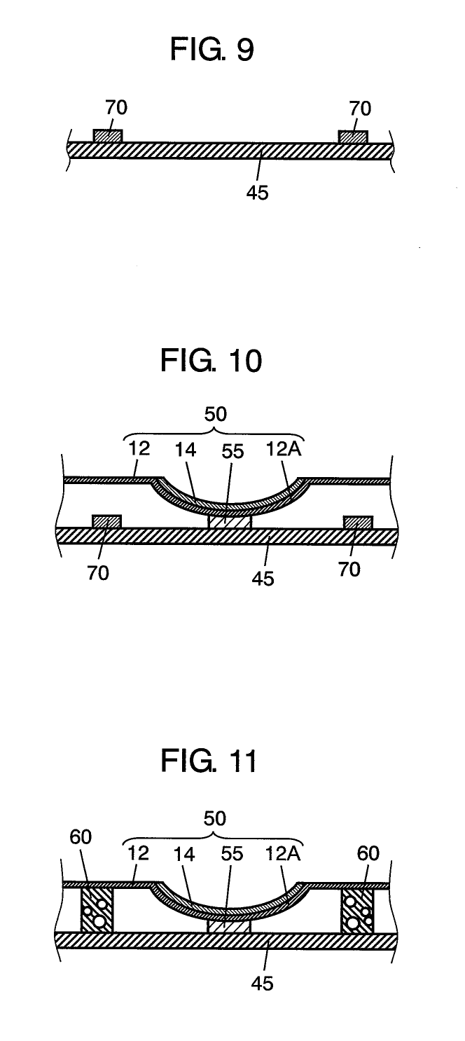

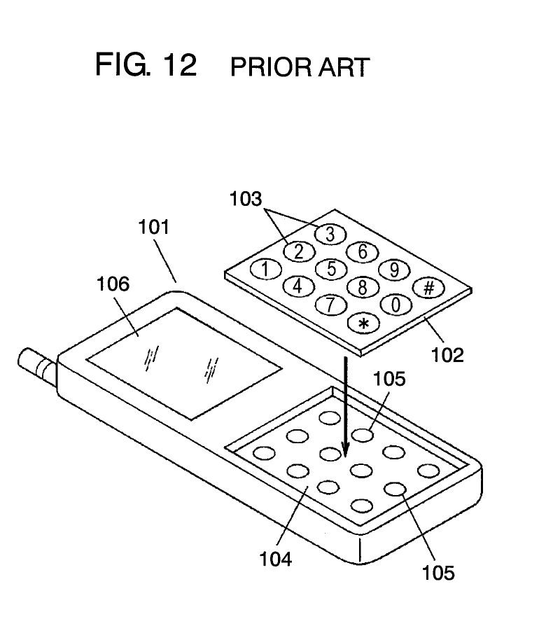

FIG. 9 is a sectional view showing a part of the module unit of the second exemplary embodiment referred to in describing a manufacturing method thereof according to the fourth exemplary embodiment of the present invention, FIG. 10 is another view of the part of the module unit associated with the same manufacturing method, and FIG. 11 is still another view of the part of the module unit associated with the same manufacturing method.

Description is provided in this fourth exemplary embodiment of a method of manufacturing the module unit, which constitutes the input device illustrated in the second exemplary embodiment. Since this manufacturing method is characterized by way of integrating capacitive sensor 45 and movable contact assembly 50 especially with cushioning members 60, the following description focuses mainly on that part.

First, capacitive sensor 45 and movable contact assembly 50 are prepared. Also prepared is resin paste 70 described above to form cushioning members 60.

In the next step, capacitive sensor 45 is placed upside down on a table, and resin paste 70 is printed on a surface facing upward by such means as screen printing to form a state of work piece shown in FIG. 9. A printing pattern used is such configuration that can form cushioning members 60 in areas around but not including spaces confronting convex portions 12A of movable contact assembly 50 so that pillar-shaped cushioning members 60 are formed in these areas.

Subsequently, movable contact assembly 50 is placed upside down on top of capacitive sensor 45, as shown in FIG. 10. In this step, movable contact assembly 50 is so placed that the upper ends of protruding portions 55 bonded beforehand to the top surfaces of convex portions 12A come in contact with the upper side surface of capacitive sensor 45. It is important in this step that movable contact assembly 50 is properly positioned and placed in a manner so that areas to be bonded with cushioning members 60 confront the areas of capacitive sensor 45 where resin paste 70 is printed. It is also preferable to use movable contact assembly 50 provided with a plurality of convex portions 12A having protruding portions 55 bonded thereto, so as to keep movable contact assembly 50 in the resting position steadily at an uniform height throughout the areas to be bonded on convex portions 12A.

Following the above, the prepared work piece is baked to bring resin paste 70 to foam. At the same time with or subsequent to the baking process, resin paste 70 is hardened to form cushioning members 60 of the shape shown in FIG. 11. The above method of forming cushioning members 60 can provide such advantages as establishing uniform heights of cushioning members 60 at the same time they are formed, and properly bonding both sides of cushioning members 60 to capacitive sensor 45 as well as sheet 12 of movable contact assembly 50 with a reduced number of the working processes. Since the above manufacturing method makes good use of the height of movable contact assembly 50 as a whole to maintain a spatial dimension between capacitive sensor 45 and movable contact assembly 50 to form cushioning members 60 of uniform heights, it can manufacture module unit 40 of the lowest profile among the invented structures. In addition, this manufacturing method of the fourth exemplary embodiment can further reduce the number of working processes and is therefore economically reasonable since it does not require a cost to make a special tool such as height setting member 75, which is not needed in this method. In the subsequent step, key mat 3 can be bonded to a surface of capacitive sensor 45 opposite the side where movable contact assembly 50 is bonded if necessary.

What has been discussed above is the example of printing resin paste 70 on capacitive sensor 45 for the subsequent manufacturing processes. However, resin paste 70 may be printed on sheet 12 of movable contact assembly 50 and bonding it to capacitive sensor 45 while restricting the heights of cushioning members 60 by capacitive sensor 45 itself. In either of these cases, it can be appropriate to use movable contact assembly 50 bonded together in advance with corresponding wiring board 20. In addition, cushioning members 60 can be formed between wiring board 20 and capacitive sensor 45 to compose the input device in the same manner.

The idea of manufacturing method according to the fourth exemplary embodiment can also be applicable to the module unit of the first exemplary embodiment. In other words, the same steps as those discussed here can be used to manufacture the module unit of the first exemplary embodiment when its cushioning members 30 have the same as that of convex portions 12A.

The input device of the present invention and the same device produced by the invented manufacturing method has the function of accepting, for example, push-on operation as well as coordinate input operation with only one and same actuating key unit. The input device also has such novel advantages as easy to assemble into an apparatus, capable of detecting a coordinate location steadily and highly accurately, and yielding a good tactile feeling to the push-on operation, and it is therefore useful for composing an input controller of any type of electronic apparatus.

According to the present invention, as has been obvious from the above, the input device can be assembled easily into an apparatus, yet capable of accepting both of push-on operation and coordinate input operation with only the single actuating key unit. Furthermore, the present invention provides the novel method of manufacturing the module unit for the input device having the advantageous features of detecting a coordinate location reliably and highly accurately, and yielding an excellent tactile feeling to the push-on operation.

The input device of the present invention has a simple structure and requires a small force to depress the cushioning members altogether when the cushioning members of the pillar shape are formed in positions around the switch elements at equal distances from the centers thereof and at equal angles. This structure also provides an advantage of alleviating an adverse influence to the tactile feeling in the switch element as well as easing adverse functioning resulting from a push-on operation applied at irregular angle.

The present invention can achieve further simplification of the structure of the input device since each of the pillar-shaped cushioning members is formed at the position midpoint along the centerline between two adjoining convex portions.

The present invention can also achieve the input device of low profile when the sensor element for coordinate input controller comprises a sheet-form capacitive sensor made of an electrode formed on a PET film, and the movable contact retainer comprises a sheet-form movable contact assembly bearing movable contacts on the underside surface of the sheet.

In the method of manufacturing the input device of the present invention, a height setting member formed into the same height as the cushioning members can be positioned between the capacitive sensor and the movable contact assembly during the step of placing one of the components in a position confronting the other component having the printed resin to set the appropriate height dimension. Use of this height setting member helps ensure uniform heights of the cushioning members.

Moreover, in manufacturing the input device of the present invention, the movable contact assembly can be placed on the other component in a manner so that the upper ends of the protruding portions provided on the top surfaces of convex portions come in contact with the upper side surface of the other component during the step of placing one of the components in a position confronting the other component having the printed resin to set the appropriate height dimension. Since this method makes good use of the height of the component used for the module unit to maintain the height dimension of the unit itself, it can manufacture the module unit of very low profile.

What is claimed is:

1. An input device comprising:
a wiring board provided with a stationary contact; and
a module unit placed on the wiring board,
wherein the module unit comprises:
an actuating key portion;
a movable contact disposed under the actuating key portion, and actuated by a push-on operation of the actuating key portion;
cushioning members disposed in a space between a lower surface of the actuating key portion and an upper surface of a movable contact retainer bearing the movable contact to make the space shrinkable when subjected to the push-on operation whereas the cushioning members maintaining an uniform space height when not subjected to the push-on operation; and
a protruding portion for depressing a top center portion of the movable contact,
wherein the actuating key portion, the movable contact, the cushioning members, and the protruding portion are integrally formed, and
further wherein the input device has a switch element comprising the movable contact and the stationary contact, and
the switch element is actuated by the push-on operation through the actuating key portion.

2. The input device of claim 1, wherein the actuating key portion is provided with a capacitive sensor bonded to it to constitute a coordinate input controller for accepting an input of coordinate data according to a change in capacitance responsive to a movement of a finger of an operator.

3. The input device of claim 1, wherein the cushioning members are formed into a pillar shape and disposed at positions around the switch element at equal distances from the center thereof and at equal angles with respect to each other.

4. The input device of claim 3, wherein each of the cushioning members is disposed at a position midpoint along a line between centers of two adjoining switch elements.

5. The input device of claim 2, wherein the capacitive sensor of the coordinate input controller comprises a sheet-form sensor element made of an electrode printed on a PET (polyethylene terephthalate) film, and the movable contact retainer comprises a sheet-form movable contact assembly bearing the movable contact on an underside surface thereof.

6. A method of manufacturing a module unit for an input device, the method comprising the steps of:
preparing a capacitive sensor and a movable contact assembly, and printing a resin paste mixed with a foaming agent on one of the capacitive sensor and the movable contact assembly in a prescribed pattern corresponding to an arrangement of cushioning members;
placing the other one of the capacitive sensor and the movable contact assembly in a manner to confront the one bearing the resin paste printed thereon with a space kept therebetween of a dimension equal to a given height of the cushioning members; and
foaming and hardening the resin paste to form the cushioning members bonded to the capacitive sensor and the movable contact assembly while maintaining the height dimension fixed by the other one of the capacitive sensor and the movable contact assembly.

7. The method of manufacturing a module unit of claim 6, wherein the step of placing the other one of the capacitive sensor and the movable contact assembly comprises a process of placing a height setting member formed into a dimension equal to the height of the cushioning members between the capacitive sensor and the movable contact assembly.

8. The method of manufacturing a module unit of claim 6, wherein the step of placing the other one of the capacitive sensor and the movable contact assembly comprises a process of placing the other one of the capacitive sensor and the movable contact assembly in a manner to bring top surfaces of a plurality of convex portions provided on the movable contact assembly or upper ends of protruding portions formed on the top surfaces into contact with the other one.
